(19) United States
(12) Patent Application Publication
(10) Pub. No.: US 2021/0404828 A1
(43) Pub. Date: Dec. 30, 2021

(54) TECHNIQUES FOR PERSONALIZING RIDE HAILING SERVICES USING SOCIAL MEDIA

(71) Applicant: QUDOS TECHNOLOGIES INC., Long Island City, NY (US)

(72) Inventor: NEIL ANTHONY ROLLON, ELMHURST, NY (US)

(73) Assignee: QUDOS TECHNOLOGIES INC., Long Island City, NY (US)

(21) Appl. No.: 17/074,905

(22) Filed: Oct. 20, 2020

Related U.S. Application Data
(60) Provisional application No. 63/043,493, filed on Jun. 24, 2020.

(51) Int. Cl. G01C 21/34

(52) U.S. Cl. CPC G01C 21/3484; G06Q 50/01; G01C 21/3492; G01C 21/3438

(57) ABSTRACT

A methodology and system, devices and computing apparatus are presented for personalizing ride hailing services. A proprietary social media platform is integrated with a computing apparatus providing ride hailing services. The proprietary social media platform allows users and drivers to selectively share comments, posts and ratings that are used to personalize rides and increase the quality of taxi-like services while minimizing risks and helping drivers better monetize the taxi-like services.

### RELATED APPLICATION

This application claims the benefit of U.S. Provisional Patent Application No. 63/043,493, filed on Jun. 24, 2020.

### BACKGROUND

### Field

The present application relates to techniques (e.g., systems, devices, apparatuses and methods) for personalizing ride hailing services with social media.

### Background Information

Ride hailing services have evolved considerably over the years with the use of technology. From the early days of taxi drivers driving around cities until a client hailed to request a ride, we moved to the early use of radio taxi services when a staffed “operation” center would receive client telephone calls and dispatch client requests via radio to all taxi drivers connected to a radio broadcast.

More recent technology developments in computer technology, mobile telecommunications, portable computing devices and navigation systems have led to the use of on-line data services where clients can request a ride using their smartphone or other similar device and taxi drivers would receive and accept the request, thereby confirming their offer of a transportation service. Such platforms and systems operate commercially and in some cases on a free basis in various countries. Examples include Lyft™, Uber™, Beat™, commercial ride hailing platforms. Such technologies have also supported the deployment of ride-sharing communities (e.g. carpooling) and other similar services.

Ride hailing platforms are designed to operate by matching clients with drivers that have available slots for offering taxi-like services to the clients and base the matching mainly on distance parameters between the provider and the consumer of the taxi-like service. In some cases, limited support for user preferences is available, typically in the form of type of car, age of car, etc.

Such limited support for client preferences leaves a lot of uncertainty and risk to the clients as they cannot have access to detailed data on driver characteristics (e.g. punctuality-on-time arrival at the pickup point, detailed services offered in the car, etc.). Some platforms provide ratings on their drivers but offer limited fine details on them. It is, thus, difficult for a client to make informed choices of drivers for a taxi-like service. This situation may result in serious risks for clients (e.g. violent or rude drivers, drivers who consistently arrive late at the pickup point, etc.), health risks (e.g. insufficiently sanitized cars, lack of personal protective equipment or bad driver etiquette concerning COVID-19 and other similar health concerns, etc.).

There is a clear need for a technical solution that can help personalize ride-hailing services, provide clients with in-depth information on drivers and improve the overall ride hailing experience and services.

### SUMMARY

The present application relates to systems, devices, apparatuses and methods of personalizing ride hailing services with social media. The application leverages various techniques and technologies in the fields of mobile computing, position tracking systems, geographic and traffic data, social networks, etc. to personalize ride hailing services. The innovative solution disclosed in the present application solves the problem of personalizing ride-hailing services, providing users (i.e. clients) with in-depth information on drivers and improving the overall ride hailing experience and services.

In a first exemplary implementation, users and drivers create profiles at a computing apparatus implementing the ride-hailing services. In a variation of the current exemplary implementation, users and drivers can import their profiles from external sources, like third party social media, and can optionally enrich the imported profiles with additional information, like user preferences, driver fee policies, etc.

Users can also create user groups for easier access and dissemination of information from and to users with similar characteristics (e.g. friends or users living in the same city, etc.), drivers can create driver groups for easier access and dissemination of information from and to drivers with similar characteristics (e.g. working for the same company, etc.), and users can create groups of favorite drivers for faster and more accurate selection of a driver matching their preferences to provide the taxi-like services. In a variation of the current exemplary implementation, users can import driver profiles from external sources, like third party social media, and pool the imported driver profiles into one or more favorite driver groups.

To help select a favorite driver, users can consult the driver's profile, and access information stored at a proprietary social media platform of the ride hailing system. Such information may be found in posts, comments and ratings of other users who have previously used the taxi-like services of the drivers. The data stored by the proprietary social media platform can be created and posted by users of the ride hailing system and can be enriched with data from third party, external social media, either public or private social media.

Users can request a ride hailing service by selecting a destination, a time/date, and a driver using a ride hailing application installed at their user device. The ride hailing service provider receives the user-selected data from the user device, fetches map data, traffic data and driver calendar data and calculates possible routes and uses them with selected drivers to define possible rides. The ride hailing service provider then shortlists a subgroup of possible rides or selects a ride and presents either of the two to the user. Upon receiving the ride information at the user devices, the user selects a preferred ride and pays for the ride.

In a certain aspect, the ride hailing service provider cannot calculate possible routes (e.g. there is no available driver at the time/date selected by the user). In this situation the ride hailing service provider requests the user to change some ride parameter and repeats calculations.

In another aspect, the user does not select a driver when requesting a ride. The ride hailing service provider then searches all available drivers matching the user's profile and being in the vicinity of the user, selects a subset or one of these drivers and performs route calculations.

In another aspect, the user does not select a driver when requesting a ride. Instead, he selects a favorite driver group. The ride hailing service provider then searches all available drivers in the selected favorite driver group and being in the vicinity of the user, selects a subset of, or one of, these drivers and performs route calculations.

In another aspect, the user requests an immediate ride. The ride hailing service responds by calculating routes using the current user and driver locations and traffic data from external servers and/or traffic data received from user driver devices.

In another aspect, the user requests a ride for a future time/date. The ride hailing service responds by calculating routes using a start location entered by the user and future driver locations estimated from the last scheduled ride to be offered by the driver prior to the time/data of the ride requested by the user, and estimated traffic data from external servers and/or traffic data stored by the ride hailing service.

In another aspect users and/or drivers can post comments and ratings on drivers and uses, respectively, during or at any time after a ride.

In another aspect users and driver can set privacy policies on who has permission to view each piece of data they register or post to the ride hailing service.

The various features and limitations of the above aspects should confine any abstract ideas to particular and practical applications of those abstract ideas using the specific technical implementations disclosed in the detailed description section of the present application such that the combination of features is not expected, routine or conventional activity and cannot be produced by a person of ordinary skill in related art without resorting to considerable experimentation. The above comments should apply to any other aspects described herein.

### BRIEF DESCRIPTION OF THE DRAWINGS

FIG. 1 shows an example high-level hardware architecture for the present ride hailing system.

FIG. 2a shows an example hardware architecture for a user device and a driver device of the ride hailing system.

FIG. 2b shows an example hardware architecture for a computing apparatus of the ride hailing system.

FIG. 2c shows an example general architecture for the processor of the computing apparatus of the ride hailing system.

FIG. 3a shows the main Software Components of a user device and a driver device.

FIG. 3b shows the main software components of a server.

FIG. 4 shows an example data architecture of the ride hailing system.

FIG. 5 shows an example ride hailing use case for creating a client account.

FIG. 6 shows an example ride hailing use case for creating a driver account.

FIG. 7 shows an example ride hailing use case for creating a user group.

FIG. 8 shows an example ride hailing use case for creating a driver group.

FIG. 9 shows an example ride hailing use case for creating a favorite driver group.

FIG. 10 shows an example ride hailing use case for scheduling a ride.

FIG. 11 shows an example ride hailing use case for posting comments and ratings on a driver.

FIG. 12 shows an example ride hailing use case for posting comments on a user.

FIG. 13 shows an example processor's hardware implementation details with multiple processors for the processing apparatus, user devices, and driver devices.

FIG. 14 shows an example processor's hardware implementation details with multiple processing cores for the processing apparatus, user devices, and driver devices.

### DETAILED DESCRIPTION

The word “exemplary” is used herein to mean “serving as an example, instance, or illustration”. Any implementation described herein as “exemplary” is not necessarily to be construed as preferred or advantageous over other implementations.

The acronym “API” is intended to mean “Application Programming Interface”.

The acronym “CD” is intended to mean “Compact Disc”.

The acronym “DSL” is intended to mean “Digital Subscriber Line”.

The acronym “DVD” is intended to mean “Digital Versatile Disc”.

The acronym “GPS” is intended to mean “Global Positioning System”.

The acronym “GUI” is intended to mean “Graphical User Interface”.

The acronym “ID” is intended to mean “IDentification”.

The acronym “OS” is intended to mean “Operating System”.

The acronym “PC” is intended to mean “Personal Computer”.

The acronym “UI” is intended to mean “User Interaction”.

The acronym “WiFi” is intended to mean “Wireless Fidelity”.

The acronym “XML” is intended to mean “eXtensible Markup Language”.

The term “device” may be used interchangeably with “device with wireless capabilities”, “smartphone”, “navigator device”, “portable computer”, “computing device”, and the like.

The term “user” may be used interchangeably with “regular user” and “ordinary user” and “client”. It may also be used to mean “customer” of a ride hailing service, “user of a taxi-like service” or “user of a service”, and “participant” in a ride hailing transaction.

The term “computing apparatus” may be used interchangeably with “device”, “apparatus”, “application server”, and preferably “server”, except where it is obvious to a reader of ordinary skill in related art that these terms refer to different things, as this is apparent by the context of the discussion in which they appear. Under any circumstance, and unless otherwise explicitly stated or implicitly hinted at in the description, these four terms should be considered to have the broadest meaning, i.e., that of encompassing all four.

The present innovative solution addresses the technical problem of personalizing ride-hailing services, providing clients with in-depth information on drivers and improving the overall ride hailing experience and services.

In the implementations described in the detailed description, the present innovative ride hailing solution offers more accurate, faster, and higher quality ride hailing services.

The present systems and methods are directed to ride hailing services but can also be used in a variety of business domains including ride sharing, and ride hailing or ride sharing in the domains of alternative means of transport such as bikes, boats, airplanes and the like. The modifications that need to be made to the exemplary implementations presented below for their application in other business domains are obvious to persons of ordinary skill in related art.

Example System Architecture

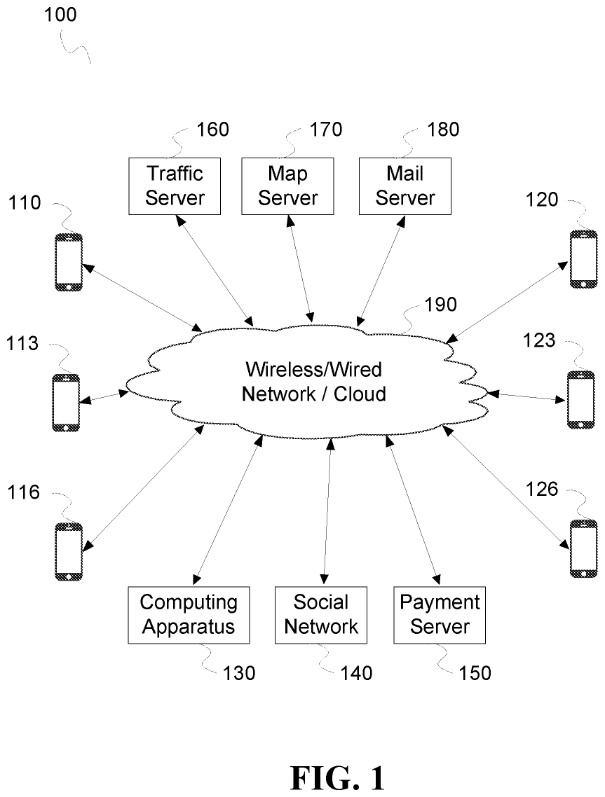

FIG. 1 shows an example high-level hardware architecture for the present ride hailing system. Ride hailing system 100 allows users operating user devices 110, 113, 116 to access and consume a variety of ride hailing services, which services relate to taxi-like services offered by drivers operating driver devices 120, 123, 126. The ride hailing services are implemented, managed and offered by computing apparatus 130 which is connected via a data network 190 with user devices 110, 113, 116 and driver devices 120, 123, 126.

User devices 110, 113, 116 may be implemented as any commercially available device, including, but not limited to, smartphones, personal digital assistants, mobile computers, portable navigators, laptops, tablets, personal computers (PC), etc. Driver devices 120, 123, 126 may be implemented as any commercially available device, including, but not limited to, smartphones, personal digital assistants, car navigation devices, car computers, mobile computers, portable navigators, tablets, etc.

In one aspect, computing apparatus 130 is also connected to a traffic server 160, a map server 170, a social network 140, a payment server 150, and a mail server 180. Servers 140-180 are external to the present system and belong to third parties, which in one exemplary implementation operate as cloud servers, while in an alternative exemplary implementation operate as web servers. It is noted that servers 140-180 are optional and when used they allow computing apparatus 130 to access live and/or historical traffic data (from traffic server 160), client and user profiles, comments, likes etc., (from social network 140), payment details and perform credit and debit actions (from payment server 150), and email addresses (from mail server 180). Servers 140-180 may be implemented as physical servers, virtual servers, cloud servers, or a combination of the previous. In alternative exemplary embodiments, some or all servers 140-180 may be merged into one or more servers.

Network 190 may be implemented in any available network technology and may be either fully wireless or a combination of wireless and wired networks. Examples include Wireless Fidelity (WiFi), cellular data networks, Zigbee, Bluetooth, the Internet, proprietary data networks etc.

Example Hardware Components of a User Device and a Driver Device

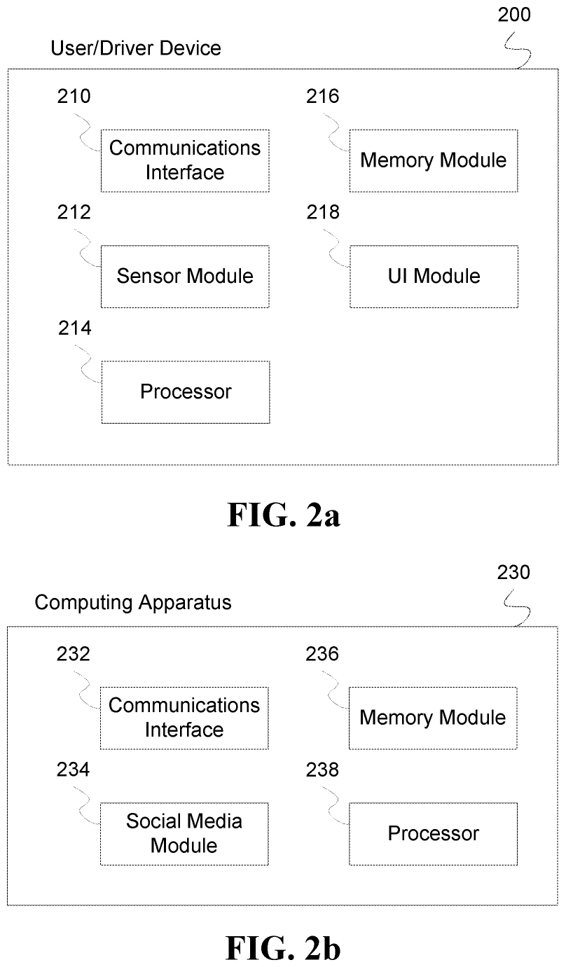

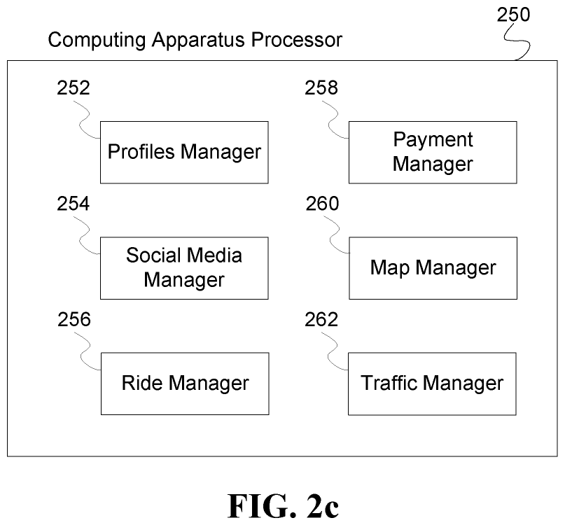

FIG. 2a shows an example hardware architecture for a user device and a driver device of the ride hailing system. Device 200 has a communications interface 210 that is suitable for connecting to one or more of the implementations of network 190 for accessing the ride hailing services. Both types of devices support wireless networks, while the user/driver device may also support wired networks. Device 200 also has a sensor module 212, a processor 214, a memory module 216 and a User Interaction (UI) module 218.

Sensor module 212 contains a sensor that collects positioning data from which the position of device 200 is calculated. Sensor module 212 can take the form of a Global Positioning System (GPS) module which uses GPS satellite data, GLONASS or Gallileo satellite positioning system module, a WiFi or other wireless system-based sensor that receives and triangulates signals from at least 3 antennae of known positions, or other wireless systems whose signals can be used to accurately calculate the position of device 200.

Processor 214 is a micro-processor module that processes information from all modules of device 200 and from external sources and allows the user to request and consume ride hailing services and the drive to offer taxi-based services that match the ride hailing services requested by the client. Processor 214 is responsible for managing and handling data received from external systems and stored in memory module 216, and for managing interactions with the users and drivers via the User Interaction (UI) module 218.

UI module 218 may be implemented in a variety of ways according to the exemplary implementation used. By means of example, UI may use a combination of a physical keyboard, a graphical keyboard, handwriting on a touch-sensitive screen or on a special pad, voice recognition of a voice signal captured by a built-in or external microphone or microphone arrays, gesture and lip movement recognition captured of video signals captured by a built-in or external camera, etc.

Device 200 may also have other hardware components like a screen, a touch screen, a microphone, a microphone array, a camera, a hard disk, a battery, a power supply, and other components not shown in FIG. 2a.

Components 210-218 and other components not illustrated in FIG. 2a are hardware modules implemented either as single microchips, or a collection of microchips and other electronic components on a single board. Each microchip or board may implement a single module or multiple modules.

Example Hardware Components of a Computing Apparatus

FIG. 2b shows an example hardware architecture for a computing apparatus of the ride hailing system. Computing apparatus 230 may be implemented as a dedicated server, a virtual server, a cloud server, a distributed group of servers, a PC, or other computing apparatus with sufficient processing power to provide ride hailing services in real time or almost in real time.

Computing apparatus 230 has a communications interface 232 that is suitable for connecting to one or more of the implementations of network 190 and supports wired networks and optionally wireless networks. Computing Apparatus 230 also has a social media module 234, a memory module 236, and a processor 238.

Social media module 234 may be a special hardware processing module, or a virtual processing module inside processor 238, implementing a social network proprietary to the ride hailing system. In a first aspect, social media module 234 only implements and manages a special social network that is dedicated to the operation of the ride hailing system. In a second aspect, social media module 234 implements and manages the special social network and also draws from and publishes data (e.g. client and driver data, etc.), content (posts, comments, likes, etc.) to external social media 140 and external mail servers 180.

Processor 238 is a micro-processor module that processes information from all modules of computing apparatus 230 and from external sources (client and driver devices 200, social networks 140, payment servers 150 and mail servers 180) and services clients and drivers in their requests and consumption of ride hailing services, and in their provision of taxi-like services, respectively. Processor 236 is responsible for managing and handling data received from external servers and systems (140-180) and data from client and driver devices 200 and storing these data in memory module 236. In an alternative exemplary implementation, processor 238 is also responsible for analyzing speech, and video signals captured from the clients and drivers via the User Interaction (UI) module 218 of device 200.

Computing apparatus 230 may also have other hardware components like a screen, a touch screen, a microphone, a camera, a hard disk, a battery, a power supply, a UI module, and other components not shown in FIG. 2b.

FIG. 2c shows an example general architecture for the processor of the computing apparatus of the ride hailing system. Processor 250 has a profile manager module 252 for managing the profiles of clients and drivers, a social media manager 254 for managing social media module 234 and external social media 140, a ride manager 256 for building, tracking and managing rides offered by drivers to clients, a payment manager 258 for handling payments effected via payment server(s) 150, a map manager 260 for creating and managing geographic information either standalone or in cooperation with map servers 170, and a traffic manager 262 for creating and managing traffic related information for helping ride manager 256 to calculate routes and build rides.

In alternative exemplary implementations, some or all modules 252-262 may be merged and new modules may be added. In some exemplary implementations, social media manager 254 may be designed to offer all the functionalities of social media module 234, effectively eliminating the need to have a separate social media module 234.

Example Software Components of a User Device and a Driver Device

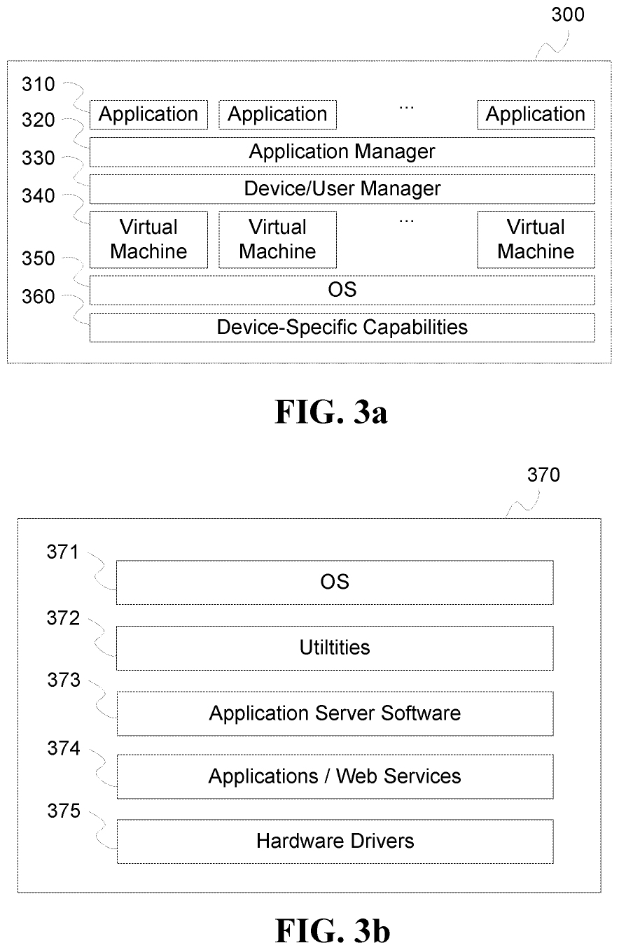

FIG. 3a shows the main Software Components of a user device and a driver device. At the lowest layer of software components 300 are Device-Specific Capabilities 360 that is the device-specific commands for controlling the various device hardware components. Moving to higher layers lie an OS 350, Virtual Machines 340 (like a Java Virtual Machine or other), Device/User Manager 330, Application Manager 320, and at the top layer, Applications 310. These applications may access, manipulate, transform and display data and communicate with other devices, and may use any protocol, standard or proprietary, used by the devices they run on or other devices or systems they connect to. In alternative exemplary embodiments some of the above components may be omitted and new components may be added.

Example Software Components of a Server

FIG. 3b shows the main software components of a server. Components 370 comprise an Operating System (OS) 371, Utilities 372, an Application Server Software 373, at least one Application or Web Service 374, and at least one Hardware driver 375. Additional software components may run on the application server while some of those shown in FIG. 3b may be omitted. One or more of software components 370 may be instantiated more than once to help speed up operation of the intent induction system and support easy scale up to cater for the needs of several concurrent users.

Example Data Architecture

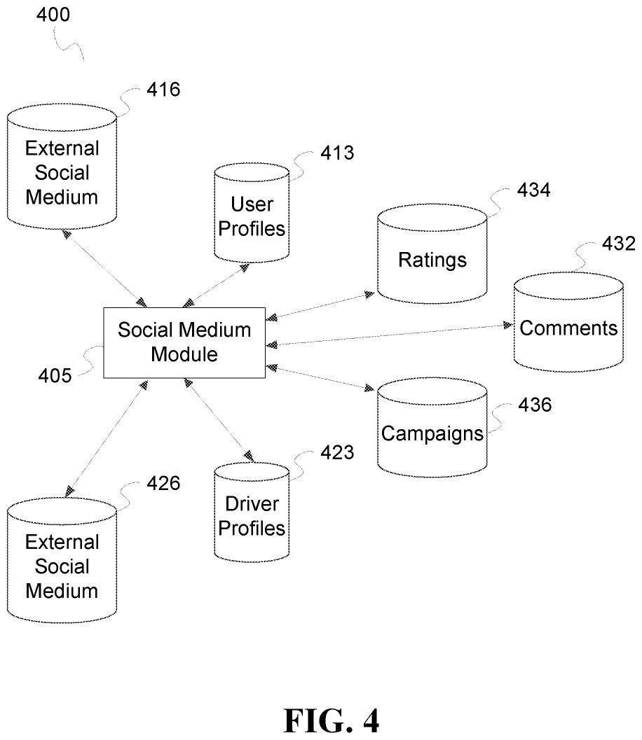

FIG. 4 shows an example data architecture of the ride hailing system. The present ride hailing system uses an innovative data collection and processing scheme as illustrated. Data architecture 400 is used by social media module 405, which draws data from internal and, optionally, external databases. In one aspect social media module 405 implements a proprietary social media platform which stores user profiles in a proprietary database 413, and driver profiles in a proprietary database 423. Users and drivers can use services offered by the ride hailing system to create, edit, and delete their profiles, users to favor drivers and enter drivers in groups of favorite drivers, to create groups of users and group of drivers, etc. Users can also use the social media module to post comments on discussions relating to drivers and users, and rate drivers, while drivers can also rate and comment users, create and post promotional campaigns, referral codes etc. These actions are handled by social media module 405, which accesses, processes and stores data in comment database 432, rating database 434, and campaign database 436. Databases 413, 423, 432, 434, 436 may be implemented either as separate databases, or as tables in one or more databases and may be stored either at memory module 216, or at a hard disk, a dedicated physical or virtual database server, on remote storage, remote database servers, cloud servers, or combinations of the previous.

In another aspect, social media module 405 implements the proprietary social media platform which stores user profiles in a proprietary database 413, and driver profiles in a proprietary database 423, and populates data profiles and the respective databases 413, 423 with data from external social media databases 416, 426, respectively. As a result, users and drivers can search and/or request from the ride hailing system to import their profiles and/or the profiles of other users and/or drivers from external social media where users and drivers already have accounts (e.g. Facebook™, Pinterest™, LinkedIn™, their work internal social media, etc.). This functionality is implemented by social media module 234 using an Application Programming Interface (API) to access the databases of the external social media where user and driver profiles and social activities (e.g. comments, ratings, posts) are stored.

Taking a closer look at a user profile, it may include a photograph or other audiovisual file, a name, an address, a telephone number, an email address, a textual description, user preferences, and other data. In one aspect a user profile may include preferences like type and age of car, driver name, age, sex, languages spoken, punctuality, politeness, availability, safety concerns (e.g. he waits for female users to enter their destination before driving away), health concerns (e.g. availability of means of personal protection, and driver practice of etiquette in line with COVID-19 and other health risks), etc.

Similarly, a driver profile may include a photograph or other audiovisual file, a name, an address, a telephone number, an email address, a textual description, user preferences 430, and other data. In one aspect a driver profile may include information like type and age of car, age, sex, languages spoken, punctuality, politeness, availability (e.g. during late hours or weekends), safety precautions (e.g. he waits for female users to enter their destination before driving away), health concerns (e.g. availability of means of personal protection, and driver practice of etiquette in line with COVID-19 and other health risks), etc.

Both user and driver profiles may be associated with comments, ratings, posts, etc. by linking database entries. This linking is implemented by selecting common database keys for the various database tables so that e.g. entries in a first database table (related to a driver) are linked with entries in a second database table (related to the same driver) etc. and, thus, one can for example pull all the data related to a specific profile, or search for profiles that fulfill certain criteria (e.g. preferences of a user).

In the previous description of the data architecture it is assumed that the database tables and the entries they contain are present for exemplary purposes and that some may be omitted, more may be added, databases and database tables may be merged, split or deleted without limiting or departing from the scope of the present innovative solution. This is obvious to any person of ordinary skill in related art.

Exemplary Use Cases

The use cases presented below are given by means of example and are not intended to limit the scope of protection and reduction to practice of the present innovative solution. More use cases can be added to the ride hailing system.

Creating a Client Account

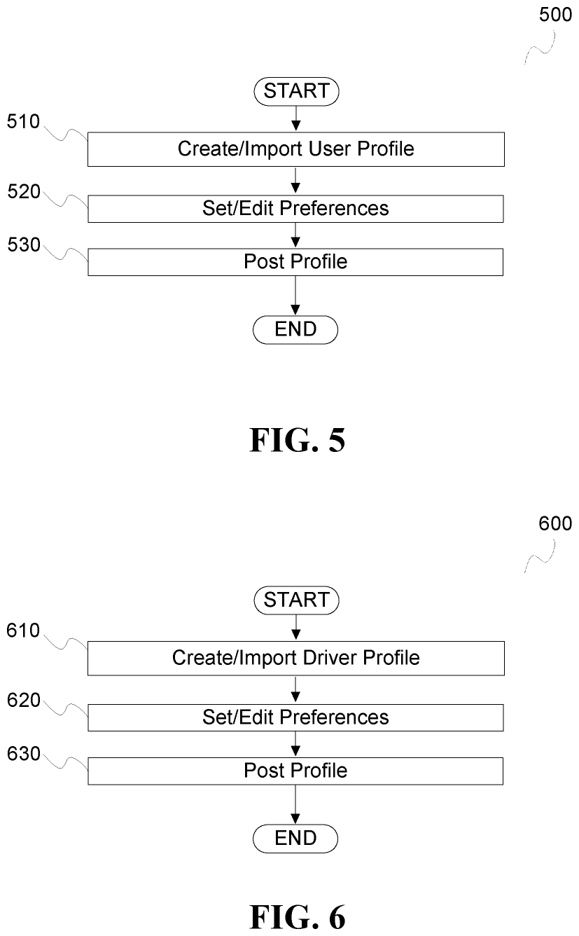

FIG. 5 shows an example ride hailing use case for creating a client account. Use case 500 starts with a client creating an account 510 at the ride hailing system. The account may be created by the user from his user device. In one aspect the user installs an application on his device and uses the application to create his account at computing apparatus 230. The same application is used in all the use cases below and works with UI module 218 for the user to access and consume all ride hailing services offered by the present system, and in particular from computing apparatus 230. The application receives the data from computing apparatus 230 via communications interface 210 and (processor 214) stores them in memory module 216. The application runs on processor 214.

In another aspect the user does not use any special application for accessing the ride hailing services. Instead, he uses any web browser application that is installed at his device 200 and connects to a webpage offered by the ride hailing system (and in particular by computing apparatus 230) where the user can interact with the system, and access and consume the ride hailing services.

In an alternative exemplary implementation, the user already has an account for the ride hailing services at computing apparatus 230. Instead of creating an account, the user connects to his existing account at computing apparatus 230 and accesses the data, associated with his existing account at memory module 236. These data are received by user device 200 via communications interface 210 and are store in memory module 216.

In yet another exemplary implementation, the user creates an account and imports the details needed to create the new account (e.g. user profile) by importing his profile from an existing account, e.g. from an external social network 140, an email account from a mail server 180, a payment server 150, or using a combination of all or some of the previous external (third-party) servers 140, 150, 180. To import his profile, the user may provide the ride hailing system (and in particular the computing apparatus 230) with the credentials of the external servers where his profile details are stored and the social media module 234 will use these credentials to connect (via communications interface 232). Upon receiving the data from external servers 140, 150, 180 via the communications interface 232, social media module 234 stores the data in memory module 236. The data can then be accessed by user device 200.

In an alternative exemplary embodiment, social media module 234 communicates its intention to connect to an external server together with the user's credentials to processor 238, and processor 238 uses communications interface 232 to connect and receive from the external server the user's profile data, which data processor 232 then stores to memory module 236.

After the data have been received and stored in memory module 236, social media module 234 accesses the data (either by directly accessing memory module 236, or via processor 238). Social media module 234 combines the data received from the external servers and in certain exemplary implementations, the received data are combined with user provided data, e.g. when additional data are entered by the user to enrich the data received from the external servers.

Having created a user account 510, the user may set or edit preferences 520 associated with his profile, and post or share his profile 530 via social media module 234 to all users and drivers registered to ride hailing system 100, or to a selected subset of these users and drivers (e.g. to his friends or to the drivers he favors, etc.).

User device 200 displays a Graphical User Interface (GUI) on a computer screen of user device 200 (not shown in FIG. 2a). The GUI is used to present information to the user and to accept his input. The GUI may be linked, in certain exemplary implementations, to a speech interface which allows the user to verbally utter commands and data needed to create his profile. The uttered data is received by a microphone (not shown in FIG. 2a) and fed to processor 214. In one aspect the voice is processed and analyzed by processor 214 and then used at user device 200 and sent to computing apparatus 230 for further actions. In another aspect, a voice representation is sent by processor 214 to computing apparatus 230 where the voice representation is analyzed and used for further actions.

The results from computing apparatus 230 are sent to user device 200 for display to the user.

The above described logic between the hardware components of user device 200, driver device 200, computing apparatus 230, and external servers 140, 150, 180 applies to all use cases. For simplicity when presenting the use cases below, some or all the logic between the hardware components is omitted. It is assumed that in analogy to the description of the “Creating a Client Account” use case, it is obvious to a reader of ordinary skill in the art how the data flows between the hardware components.

Creating a Driver Account

FIG. 6 shows an example ride hailing use case for creating a driver account. Use case 600 starts with a driver creating an account 610 at the ride hailing system. The account may be created by the driver from his driver device. In one aspect the driver installs an application on his device and uses the application to create his account at computing apparatus 230. The application works with UI module 218 for the driver to access and consume all ride hailing services offered by the present system, and in particular from computing apparatus 230. The application receives the data from computing apparatus 230 via communications interface 210 and (processor 214) stores them in memory module 216. The application runs on processor 214.

In another aspect the driver does not use any special application for accessing the ride hailing services. Instead, he uses any web browser application that is installed at his device 200 and connects to a webpage offered by the ride hailing system (and in particular by computing apparatus 230) where the driver can interact with the system and access and consume the ride hailing services.

In an alternative exemplary implementation, the driver already has an account for the ride hailing services at computing apparatus 230. Instead of creating an account, the user connects to his existing account at computing apparatus 230 and accesses the data, associated with his existing account at memory module 236. These data are received by driver device 200 via communications interface 210 and are store in memory module 216.

In yet another exemplary implementation, the driver creates an account and imports the details needed to create the new account (e.g. driver profile) by importing his profile from an existing account, e.g. from an external social network 140, an email account from a mail server 180, a payment server 150, or using a combination of all or some of the previous external (third-party) servers 140, 150, 180. To import his profile, the driver may provide the ride hailing system (and in particular the computing apparatus 230) with the credentials of the external servers where his profile details are stored and the social media module 234 will use these credentials to connect (via communications interface 232). Upon receiving the data from external servers 140, 150, 180 via the communications interface 232, social media module 234, stores the data in memory module 236. The data can then be accessed by driver device 200.

In an alternative exemplary embodiment, social media module 234 communicates its intention to connect to an external server together with the driver's credential to processor 238, and processor 238 uses communications interface 232 to connect and receive from the external server the driver's profile data, which data processor 232 then stores to memory module 236.

After the data have been received and stored in memory module 236, social media module 234 accesses the data (either by directly accessing memory module 236, or via processor 238). Social media module 234 combines the data received from the external servers and in certain exemplary implementations, the received data are combined with driver provided data, e.g. when additional data is entered by the driver to enrich the data received from the external servers.

Having created a driver account 510, the driver may set or edit user preferences 520 associated with his profile, and post or share his profile 530 via social media module 234 to all users and drivers registered to ride hailing system 100, or to a selected subset of these users and drivers (e.g. to his friends or to the drivers of certain work group or company, to users he favors, etc.).

Driver device 200 displays a Graphical User Interface (GUI) on a computer screen of driver device 200 (not shown in FIG. 2a). The GUI is used to present information to the driver and to accept his input. The GUI may be linked, in certain exemplary implementations, to a speech interface which allows the driver to verbally utter commands and data needed to create his profile. The uttered data are received from a microphone (not shown in FIG. 2a) and fed to processor 214. In one aspect the voice is processed and analyzed by processor 214 and then used at driver device 200 and sent to computing apparatus 230 for further actions. In another aspect, a voice representation is sent by processor 214 to computing apparatus where the voice representation is analyzed and used for further actions.

The results from computing apparatus 230 are sent to driver device 200 for display to the driver.

Creating a User Group

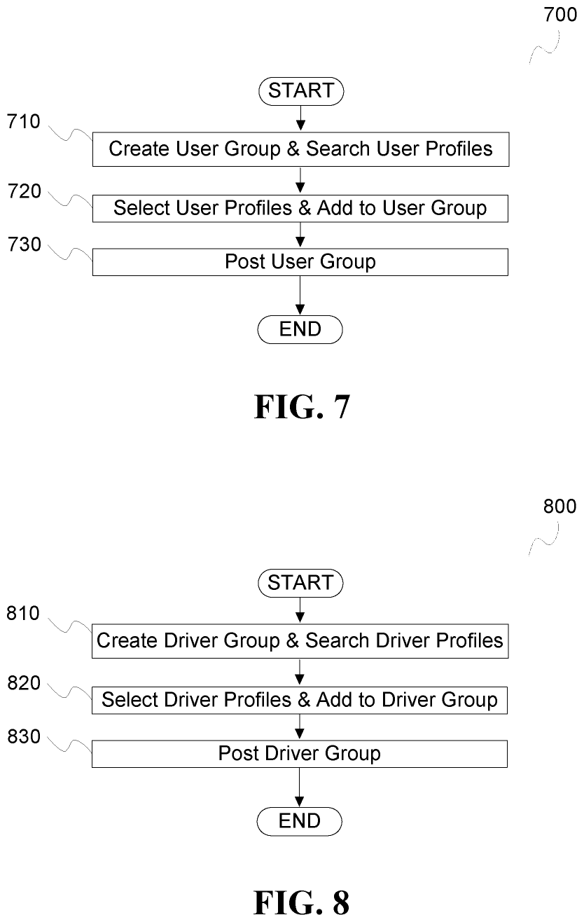

FIG. 7 shows an example ride hailing use case for creating a user group. Use case 700 starts with a user creating a user group 710. The group name and parameters may be set via the GUI or via the GUI and speech interface. To create the contents of the user group, the user may simply type the name of the users he wants to add and receive a list of profiles matching the entered name. Alternatively, the user may browse using other parameters (e.g. location) to search and browse datails. Upon being presented with a list of users, the user may select any number of users he wants and add them to the user group 720. Selecting and adding users to the user group can be done graphically by clicking or dragging-n-dropping profiles in the group, verbally, e.g. by reading a distinguishing parameter of the profile of interest, such as the full name, an IDentification (ID) number, a street address, a telephone number, an email address etc. The same distinguishing parameters can also be used in searching step 710. Having populated the new group with users, the user posts the group 730.

Such user groups are useful for sharing experiences, comments, posts, ratings etc. among users who may be friends of the user which creates the user group or simply users with a common characteristic (e.g. they live in the same city), etc. The benefit of using user groups is that the user can quickly and simply get information on a driver, a route etc. (especially information relating to quality of driver services, safety and hygiene) and facilitate himself into planning a trip.

Creating a Driver Group

FIG. 8 shows an example ride hailing use case for creating a driver group. Use case 800 starts with a driver creating a driver group 810. The group name and parameters may be set via the GUI or via the GUI and speech interface. To create the contents of the driver group, the driver may simply type the name of the drivers he wants to add and receive a list of profiles matching the entered name. Alternatively, the driver may browse using other parameters (e.g. location) to search and browse. Upon being presented with a list of drivers, the driver may select any number of drivers he wants and add them to driver group 820. Selecting and adding driver to the driver group can be done graphically by clicking or dragging-n-dropping profiles in the group, verbally, e.g. by reading a distinguishing parameter of the profile of interest, such as the full name, an IDentification (ID) number, a street address, a telephone number, an email address etc. The same distinguishing parameters can also be used in searching step 810. Having populated the new group with drivers, the driver posts the group 830.

Such driver groups are useful for sharing experiences, comments, posts, ratings etc. among drivers who usually are friends or business partners of the driver which creates the driver group. The benefit of using driver groups is that the driver can quickly and simply share information with drivers (e.g. route conditions), experiences and ratings of users (e.g. rude users to avoid) and facilitate the driver into planning the services he offers to users via system 100 (e.g. better scheduling of the driver-offered rides based on availability or profitability, suggest a substitute driver and car to a user if he is not available, plan promotions, etc.).

Creating a Favorite Driver Group

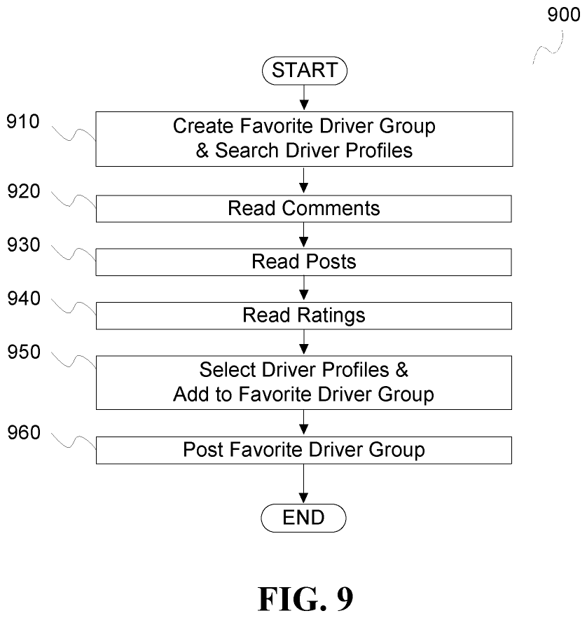

FIG. 9 shows an example ride hailing use case for creating a favorite driver group. Use case 900 starts with a user creating 910 a favorite driver group by selecting the group name and parameters via the GUI or via the GUI and speech interface. To create the contents of the favorite driver group, the user may search for drivers 910 by simply typing the name of the drivers he wants to add and receive a list of profiles matching the entered name. Alternatively, the user may browse using other parameters (e.g. safety and hygiene parameters, type of car, age of car etc.). In addition to the previous parameters, the user may also browse user comments 920, posts 930, and ratings 940 related to drivers and use them to select the drivers 950 he wants to add to the favorite driver group. Selecting and adding drivers to the favorite driver group 950 can be done graphically by clicking or dragging-n-dropping profiles to the group, verbally (e.g. by reading a distinguishing parameter of the profile of interest, such as the full name, an IDentification (ID) number, a street address, a telephone number, an email address, etc.) or a combination of both interaction methods. The same distinguishing parameters can also be used in searching step 910. Having populated the new favorite driver group with drivers, the driver posts the group 960. Such favorite driver groups are useful for quickly and simply selecting drivers when scheduling a ride. It is possible to have more than one favorite driver groups were each group is associated, for example, with a different type ride, such as a first favorite driver group for short rides, a second favorite driver group for long rides, and a third favorite driver group for transporting bulky objects, etc.

Having defined favorite driver groups, the user may browse a specific favorite driver group to select a driver when requesting a ride, or he may simply select a group and let the ride hailing system automatically select a driver from the selected group based on parameters like driver's availability (as set in the driver's calendar), driver's distance from the starting point of the ride (as set by the driver's current location for an immediate ride, or the estimated driver's location for a future ride), time needed for driver to arrive at the starting point of the ride (as set by the driver's current location and traffic conditions, or estimated drivers location for a future ride and estimated traffic conditions). The current driver position is defined by sensor module 212. The driver's availability is calculated from the driver's calendar. The estimated (future) location is estimated by processor 238 using position readings from sensor module 212, driver's calendar, planned routes from map server 170, traffic conditions from traffic server 160, etc. The time needed for the driver to arrive at the starting point of the ride is estimated by processor 238 using position readings from sensor module 212, driver's calendar, planned routes from map server 170, traffic conditions from traffic server 160, etc. The driver's distance from the starting point of the ride is calculated from the driver's current location for an immediate ride, or the estimated driver's location for a future ride. The time needed for the driver to arrive at the starting point of the ride is calculated using the driver's current location, route, and traffic conditions.

Scheduling a Ride

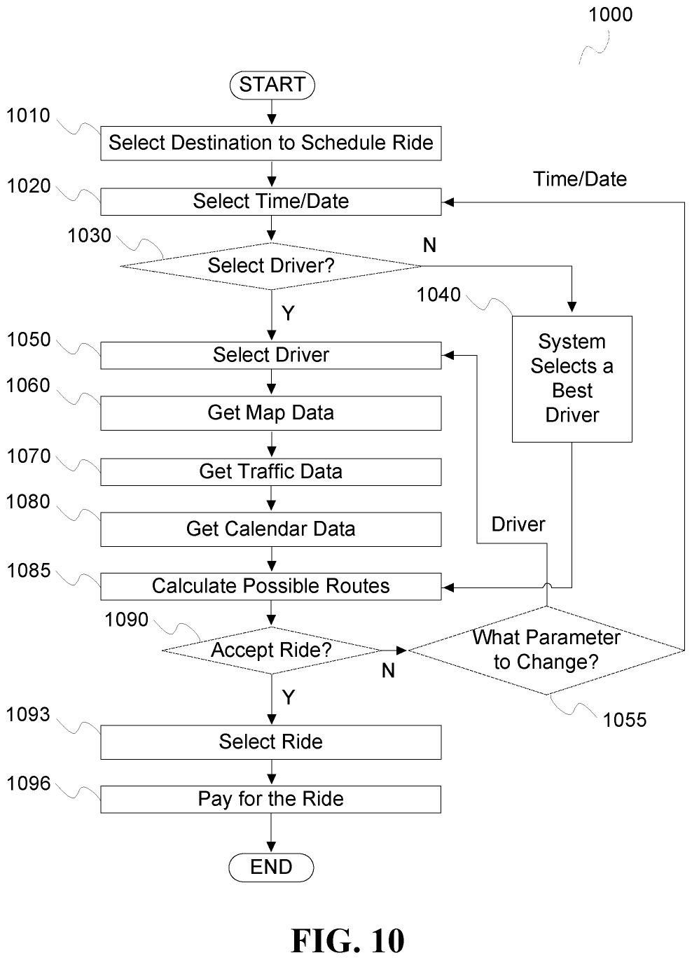

FIG. 10 shows an example ride hailing use case for scheduling a ride. Use case 1000 starts with the user selecting a destination 1010. The user's selection may be performed graphically by entering an address on a destination field presented to the user on the screen of his user device 200, or by selecting a point on a map presented on the same screen. Alternatively, the user may verbally utter the destination, which is captured by a microphone on user device 200, and his utterance is analyzed either on user device 200 or on computing apparatus 230. From the analyzed speech, an estimation of the destination address (or a list possible destination addresses) is produced which is presented to the user either visually (on a map, as text on the destination field, or both) or verbally via a speaker at the user device 200. The user confirms (graphically or verbally) the destination address or enters it again.

The user then selects a time and date 1020 for the ride. The user may select the time and date either graphically by entering an address on a time-date field presented to him on the screen of his user device 200, or by selecting a graphical calendar presented on the same screen. Alternatively, the user may verbally utter the time and date, which is captured by a microphone or microphone array on user device 200. The verbally entered time and date is identified (either locally at user device 200, or at computing apparatus 230) and presented to the user visually (on a calendar or as text on the time-date field) or verbally via a speaker at the user device 200.

Having selected a destination and a time and date for his ride, the user is then given the choice to select a driver 1030. The may select a driver 1050 by typing a driver's name or other identifying parameter related to the driver of his choice (e.g. telephone number, street address, email address, identification number, car license plate, etc.). Alternatively, the user may browse a list of drivers and select by name, photograph, or other parameter. The user may browse all registered drivers or use filters to limit his choice to only those drivers that are more relevant, e.g. drivers with an empty slot in their calendars for the selected time and date, drivers within a user-defined distance from the start location of the ride, drivers within a user-defined estimated time to arrive to the start location of the ride, users with ratings above a user-defined rating in one parameter (e.g. hygiene, or car age, etc.) on for all parameters, etc. The user may also be presented with drivers only from one or more of the user's favorite driver groups. Before making his selection, the user may browse driver profiles, and comments and posts associated with these profiles.

Having selected a driver for his ride, processor 238 of computing apparatus 230 fetches map data 1060 from memory module 236 or from map server 170, traffic data 1070 acquired from sensor modules 212 of user devices and driver devices 110, 113, 116, 120, 123, 126 (which are stored in memory module 236), or from traffic server 160, and calendar data 1080 of the selected driver (stored in memory module 236 or at the driver device's memory module 218).

Using the map 1060, traffic 1070 and calendar 1080 data processor 238 calculates one or more possible routes 1085 from the start point to the destination of the ride and evaluates the feasibility 1090 of the selected driver making the ride. If it is feasible 1090, processor 238 selects the ride 1093.

If the selection is not feasible 1090, then the user is asked what parameter of the ride the user would like to change 1055. If the user wants to select another time and date then he is taken to step 1020, while if the user wants to select another driver, then the user is taken to step 1050.

Having selected ride 1093, the user pays 1096 for the ride. To pay for the ride 1096, processor 238 of computing apparatus 230 presents a payment screen to the user device's 200 screen and uses the payment services of payment server 150 (e.g. a bank payment server, or a credit card issuer payment server). The user enters his credit card details and validation codes according to any commercially available validation methodology supported by payment server 150.

In an alternative exemplary implementation, steps 1060, 1080 (and optionally step 1070) are placed immediately before step 1050, so that processor 238 can check which drivers are (or will be) available for the user-selected time and data 1020 and are (or will be) at a pre-defined proximity to the start location of the ride. This way, processor 238 can present to the user only the available drivers nearby the start location of the ride, drawn either from the pool of all drivers registered with computing apparatus 230, or from the user-defined favorite driver group(s) 900. As a result of this modification, the user is prevented from selecting drivers that are not available for the selected time and date, and the implementation of use case 1000 is sped up also freeing memory and computational resources.

In step 1030 the user may decline to select a driver or may select one or more group of drivers 800 or one or more favorite driver groups 900. This leaves it up to processor 238 to select a best driver 1040 according to the parameters of the ride and the user preferences associated with the user's profile. The workload of processor is reduced if the user selects one or more group of drivers 800 or one or more favorite driver groups 900 as opposed to when the user makes no selection. Among the candidate drivers (i.e. available to offer the ride), the choice is biased by the driver's position (i.e. current position for an immediate ride, or estimated future position for a planned ride at a later time-date) and the estimated time to arrive at the start location of the ride.

The availability of a driver is determined by processor 238 from the driver's calendar 1080 (stored at memory module 216 and/or memory module 236, or at an external server). The current position of a driver is determined by processor 238 from the readings of sensor module 212 at driver device 200. The estimated future position of the driver is calculated by processor 238 using the driver's confirmed last route before the requested route by the user (stored at memory module 216), map data 1060 from map server 170, traffic data 1070 from traffic server 160 and optionally from user devices 110, 113, 116 and driver devices 120, 123, 126. The estimated time to arrive at the start location of the ride is calculated by processor 238 using the driver's current or estimated position, the driver's confirmed last route before the requested route by the user (stored at memory module 216), map data 1060 from map server 170, traffic data 1070 from traffic server 160 and optionally from user devices 110, 113, 116 and driver devices 120, 123, 126.

Driver Accepting a Ride

In the above exemplary implementation, once a user requests a ride and the system schedules the ride, the driver is informed of the ride request and offered the option to accept or decline, which decision is then communicated by processor 238 to the user. In this use case it is assumed that the driver has previously set in his profile a fee policy (e.g. based on $/mile, extra fee for late hours, etc.) which fee policy is used by processor 238 to automatically calculate the cost of the ride before the ride is presented to the user for confirmation and payment.

The fee policy may be defined in a descriptive programming language or representation like the eXtensible Mark-up Language (XML). The fee policy is in effect a structured representation of fee data and metadata which is structured according to data privileges (please refer to the “Data Privileges” section for more information).

In an alternative exemplary implementation, use case 1000 is modified to include additional steps before presenting the offer to the user in step 1090. In step 1085 more than one possible rides and/or routes are selected and sent to a set of available drivers (according to data 1060, 1070, 1080, and user-defined favorite driver groups) who can bid on the ride/route, offering their preferred fee and, optionally, alternative incentives (e.g. coupons for future rides with them, etc.). The bids are presented to the user who then selects the preferred bid 1090.

Posting Comments and Rating on a Driver

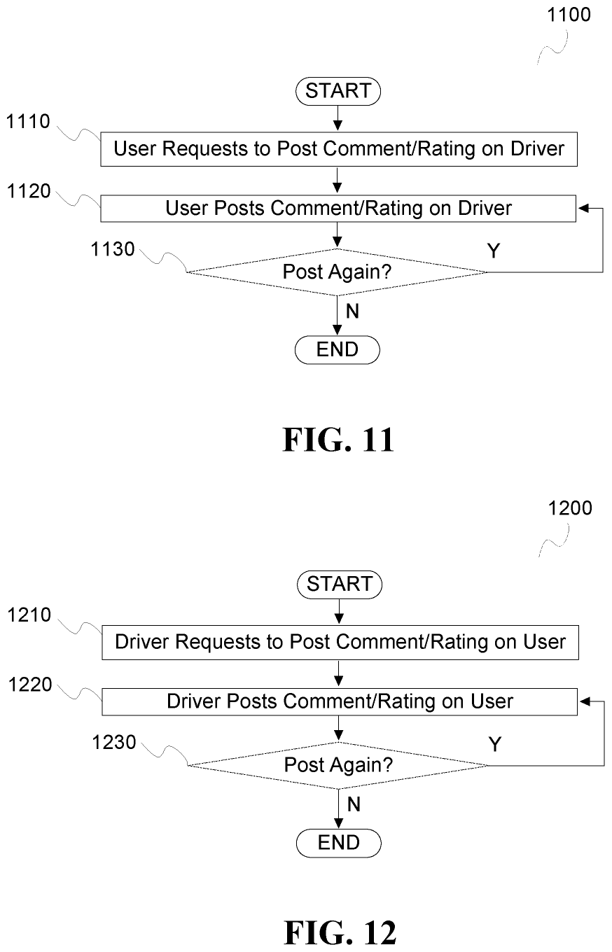

FIG. 11 shows an example ride hailing use case for posting comments and ratings on a driver. Use case 1100 is initiated by a user during or after the completion of a ride. During the ride, processor 238 receives the user's request to comment or rate the driver of the current ride and automatically selects the profile of the current driver 1110.

The user then posts a comment or a rating 1120 and processor 238 forwards the comment or rating to social media module 234 for posting to the social network of ride hailing system 100. Processor 238 then checks if the user wants to post another comment or rating 1130, and branches to step 1120. If the user has finished posting 1130, then use case 1100 ends. In a variation of the present exemplary implementation, use case 1100 is implemented by social media module 234 without the intervention of processor 238.

If a user wants to post after the completion of a ride, use case 1100 is initiated by the user sending to processor 238 a request to comment or rate a driver 1110. The user then searches/browses and selects the profile of the driver on who he wants to post 1110.

The user then posts a comment or a rating 1120 and processor 238 forwards the comment or rating to social media module 234 for posting to the social network of ride hailing system 100. Processor 238 then checks if the user wants to post another comment or rating 1130, and branches to step 1120. If the user has finished posting 1130, then use case 1100 ends. In a variation of the present exemplary implementation, use case 1100 is implemented by social media module 234 without the intervention of processor 238.

User ratings and posts on drivers are stored by processor 238 and/or social media module 234 at comments database 432, and ratings database 434 together with database keys associating the comments and ratings with the client posting them and the driver they refer to.

User's comments and ratings of drivers are invaluable to the present innovative ride hailing system, as they are used by the community of users in the present social media platform for selecting drivers using tangible data instead of random choices or based only on driver profile data. As a result, better user satisfaction is achieved, security is enhanced, and the provider of the ride hailing services system 100 increases his revenues, while good drivers are rewarded.

Posting Comments and Ratings on a User

FIG. 12 shows an example ride hailing use case for posting comments on a user. Use case 1200 is initiated by the user after the completion of a ride. After the ride, processor 238 receives the driver's selection of the user he transported and the driver's request to comment or rate the selected user of 1210.

The driver then posts a comment or a rating 1220 and processor 238 forwards the comment or rating to social media module 234 for posting to the social network of ride hailing system 100. Processor 238 then checks if the driver wants to post another comment or rating 1230, and branches to step 1220. If the driver has finished posting 1230, then use case 1200 ends. In a variation of the present exemplary implementation, use case 1200 is implemented by social media module 234 without the intervention of processor 238.

A driver can post a comment or rating on a user at any time after transporting this user. In such a scenario of use case 1200, the driver searches/browses a user and selects the user's profile, and requests from processor 238 to post 1210.

The driver then posts a comment or a rating 1220 and processor 238 forwards the comment or rating to social media module 234 for posting to the social network of ride hailing system 100. Processor 238 then checks if the driver wants to post another comment or rating 1230, and branches to step 1220. If the driver has finished posting 1230, then use case 1200 ends.

Driver ratings and posts on users are stored by processor 238 and/or social media module 234 at comments database 432, and ratings database 434 together with database keys associating the comments and ratings with the driver posting them and the user they refer to.

Driver's comments and ratings of users are invaluable to the present innovative ride hailing system, as they are used by the community of drivers in the present social media platform for selecting users to offer their taxi-like services using tangible data instead of random choices or based only on user profile data. As a result, higher driver security is achieved, and the provider of the ride hailing services system 100 increases his revenues, while good users are rewarded with discounts and other incentives from the drivers.

Data Privileges

Ride hailing system 100 collects, processes, and discloses data from users, drivers and third parties. Such data fall into three categories with regard to the ride hailing system: public, internal, and private.

Public data are data from external sources (e.g. map data from map server 170 and traffic data from traffic server 160), which are viewable from anyone accessing such services. By means of example, public data are map data from Google Maps™, which are viewable by anybody with Internet access. Public data may also be data from proprietary servers which are external to the ride hailing system and which are accessible by anyone having access (typically via membership) to the proprietary services offered by such servers.

Internal data are data created in and stored at the ride hailing system and are viewable by any of the registered members of the ride hailing system. These data may include driver location, some social media module 234 data (e.g. comments and ratings on drivers), etc.

Private data are data created and used only inside the ride hailing system but are viewable only by a selected set of users (e.g. user's favorite divers, comments and posts to selected users, etc.), a selected set of drivers (e.g. comments and ratings on users), or the owner of the data (e.g. credit card data, etc.).

Certain types of data, referred to as hybrid data, may be parameterized as to who has the right to view them (e.g. the user preferences which are visible in his profile, a user's or driver's email address, phone number and street address, driver's fee policy, driver's campaign data, etc.).

The present ride hailing system uses a data policy to define and implement data privileges using the data categories presented above. Such data policy is described in any programming language or representation, including descriptive languages and representations (e.g. XML) for easy portability across hardware and software platforms.

Using the data policy, a user, a driver, or a system administrator can accurately visualize who can view every piece of data and can edit the data policy for defining in greater detail who can view e.g. hybrid data.

The data policy offers another advantage to system administrators. It can be easily and quickly adapted and parameterized according to the data protection and related legislations when they change of when the ride hailing services are offered in other countries.

Example Processor Hardware Implementations Details for the Processing Apparatus, User Devices, and Driver Devices

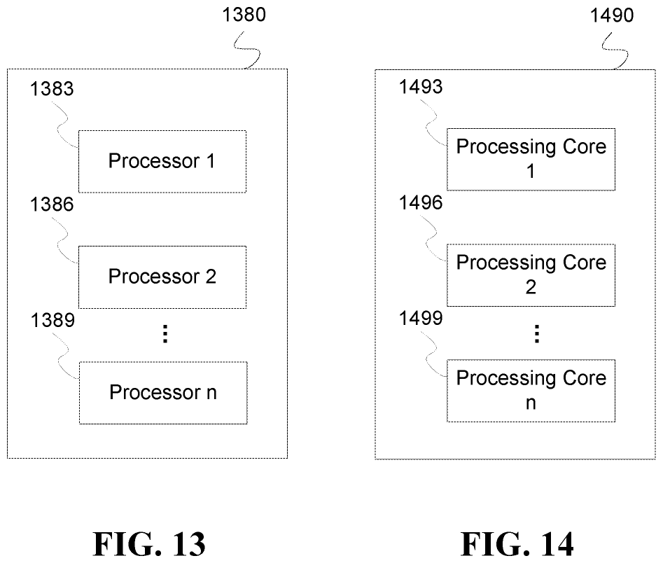

FIG. 13 shows an example processor's hardware implementation details with multiple processors for the processing apparatus, user devices, and driver devices. Processing apparatus 230, user devices 200, and driver devices 200 each have more than one processors 1380; processor_1 1383, processor_2 1386, . . . , processor_n 1389. These processors are connected via a bus (not shown) and may function in a first exemplary implementation in a peer-to-peer setup and in a second exemplary implementation as a master-slave setup where one of the three processors acts as master and the other processors act as slaves. Processors 1383, 1386, 1389 may each be configured to execute one or more modules of processing apparatus 230, user devices 200, and driver devices 200.

The use of processors 1383, 1386, 1389 allows faster processing and also allows concurrent use of multiple users while allowing easy scale up even at hot operation.

In other exemplary implementations, processor 1383, 1386, 1389 may execute modules of processing apparatus 230, user devices 200, and driver devices 200 in a redundant mode so as to enable uninterrupted operation in the event of hardware failure of any of processors 1383, 1386, 1389.

FIG. 14 shows an example processor's hardware implementation details with multiple processing cores for the processing apparatus, user devices, and driver devices. Processing apparatus 230, user devices 200, and driver devices 200 each have more than one processing cores 1490; processing_core_1 1493, processing_core_2 1496, . . . , processing_core_n 1499. These processing cores 1490 are connected via a bus (not shown) and may function in a first exemplary implementation in a peer-to-peer setup and in a second exemplary implementation as a master-slave setup where one of the three processing cores acts as master and the other processors act as slaves. Processing cores 1493, 1496, 1499 may each be configured to execute one or more modules of processing apparatus 230, user devices 200, and driver devices 200.

The use of processing cores 1493, 1496, 1499 allows faster processing and also allows concurrent use of multiple users while allowing easy scale up even at hot operation.

In other exemplary implementations, processing cores 1493, 1496, 1499 may execute modules of processing apparatus 230, user devices 200, and driver devices 200 in a redundant mode to enable uninterrupted operation in the event of hardware failure of any of processing cores 1493, 1496, 1499.

In another exemplary implementation, each or some of processors 1383, 1386, 1399 have multiple processing cores like 1493, 1496, 1499.

In a modification of the above exemplary embodiments, the data stored in databases is implemented as database tables using common database keys associating two or more database tables together, or as pointers to linked lists with entries created from the databases tables.

The above exemplary implementations are intended for use as a standalone system, apparatus or method for managing and providing ride hailing services.

The above exemplary implementations descriptions are simplified and do not include hardware and software elements that are used in the implementations but are not part of the current invention, are not needed for the understanding of the implementations, and are obvious to any user of ordinary skill in related art. Furthermore, variations of the described method, system architecture, and software architecture are possible, where, for instance, method steps, and hardware and software elements may be rearranged, omitted, or new added.

Various implementations of the invention are described above in the Detailed Description. While these descriptions directly describe the above implementations, it is understood that those skilled in the art may conceive modifications and/or variations to the specific implementations shown and described herein unless specifically excluded. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or any other device or apparatus operating as a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for personalizing ride hailing services, the system comprising:
at least a user computing device associated with a user, the at least one user computing device comprising (a) a communications interface for accessing the ride hailing services, (b) a sensor module for capturing location-based data associated with the user, (c) a processor for processing and consuming the ride hailing services, (d) a memory module for storing data associated with at least one user, with at least one driver, and with the ride hailing services, and (e) a user interaction module for interacting with the user;
at least a driver computing device associated with a driver, the at least one driver computing device comprising (a) a communications interface for accessing the ride hailing services, (b) a sensor module for capturing location-based data associated with the driver, (c) a processor for processing and consuming the ride hailing services, (d) a memory module for storing data associated with at the least one driver, with at the least one user, and with the ride hailing services, and (e) a user interaction module for interacting with the driver; and
a computing apparatus comprising (a) a communications interface for serving the ride hailing services to the at least one user computing device and to the at least one driver computing device, (b) a social media module for selectively associating the at least one user with the at least one driver and with the at least one ride hailing service, with data and ratings associated with the at least one user, with data and ratings associated with the at least one driver, with data associated with at least one calendar, and with data associated with at least one map and with traffic conditions, (c) a memory module for storing data associated with the at least one driver, with the at least one user, with the ride hailing services, with the social media module, with the at least one calendar, with the at least one map and with the traffic conditions, and (d) a processor for managing and serving the ride hailing services using the social media module, and the data associated with the at least one calendar, with the at least one map and with the traffic conditions.

2. The system of claim 1, wherein the ride hailing services comprise:
creating a user profile using the social media module;
setting user preferences using the social media module;
creating a group of users and associating the group of users with at least one user using the social media module;
creating a driver profile using the social media module;
creating a driver group and associating the driver group with at least one driver using the social media module;
creating a group of favorite drivers and associating the group of favorite drivers with one user profile and with at least one driver profile using the social media module;
creating a ride by having the user select a start location, a destination, a time-date, and a driver using data from the social media module, and the processing apparatus creating a ride using the data from the map server, the traffic server, and the calendar;
creating a ride by having the user select a start location, a destination, a time-date, and at least one favorite driver group using data from the social media module, and the processing apparatus creating at least one ride using the data from the social media module, the map server, the traffic server, and the calendar;
creating a ride by having the user select a start location, a destination, and a time-date, and the processing apparatus first selecting a driver using the data from the social media module and then creating a ride using the data from the map server, the traffic server, and the calendar;
confirming the created ride; and
paying the cost of the confirmed ride using a payment server.

3. The system of claim 2, wherein:
the map is implemented either as (a) a module of the computing apparatus, or (b) as an external service accessed by the computing apparatus, or (c) partly as the module of the computing apparatus and partly as the external service; and
the traffic conditions are created either by (a) the computing apparatus by processing location-based data received from and associated with the user and with the at least one driver, or (b) an external service, or (c) partly by the computing apparatus and partly by the external service.

4. The system of claim 3, wherein the social media module for selectively associating the user with the at least one driver and with at least one ride hailing service, with data and ratings associated with the at least one user, with data and ratings associated with the at least one driver, with data associated with at least one calendar, and with data associated with the at least one map and with traffic conditions, uses common database keys associating two or more database tables together, or pointers to linked lists with entries created from the databases tables.

5. The system of claim 2, wherein the creating the group of favorite drivers comprises the user performing at least one of:
browsing driver profiles stored by the social media module;
browsing comments associated with the driver profiles and stored by the social media module;
browsing ratings associated with the driver profiles and stored by the social media module;
selecting at least one driver using the comments and ratings associated with the driver profiles; and
associating the selected at least one driver with the group of favorite drivers.

6. A computing apparatus for personalizing ride hailing services, the computing apparatus comprising:
a communications interface for serving the ride hailing services to at least one user computing device associated with at least one user and to at least one driver computing device associating with at least one driver;
a social media module for selectively associating at least one user with at least one driver and with at least one ride hailing service, with data and ratings associated with the at least one user, with data and ratings associated with the at least one driver, with data associated with at least one calendar, and with data associated with at least one map and with traffic conditions;
a memory module for storing data associated with the at least one driver, with the at least one user, with the ride hailing services, with the social media module, with the at least one calendar, with the at least one map and with the traffic conditions; and
a processor for managing and serving the ride hailing services using the social media module, and the data associated with the at least one calendar, with the at least one map and with the traffic conditions.

7. The computing apparatus of claim 6, wherein the ride hailing services comprise:
creating a user profile using the social media module;
setting user preferences using the social media module;
creating a group of users and associating the group of users with at least one user using the social media module;
creating a driver profile using the social media module;
creating a driver group and associating the driver group with at least one driver using the social media module;
creating a group of favorite drivers and associating the group of favorite drivers with one user profile and with at least one driver profile using the social media module;
creating a ride by (a) receiving from the user device a start location, a destination, a time-date, and a driver and (b) using the data from the map server, the traffic server, and the calendar;
creating a least one ride by (a) receiving from the user device a start location, a destination, a time-date, and at least one favorite driver group and (b) using the data from the social media module, the map server, the traffic server, and the calendar;
creating a ride by (a) receiving from the user a start location, a destination, and a time-date, (b) selecting a driver using the data from the social media module and (c) creating a ride using the data from the map server, the traffic server, and the calendar;
confirming the created ride; and
paying the cost of the confirmed ride using a payment server.

8. The computing apparatus of claim 7, wherein:
the map is implemented either as (a) a module of the computing apparatus, or (b) as an external service accessed by the computing apparatus, or (c) partly as the module of the computing apparatus and partly as the external service; and
the traffic conditions are created either by (a) the computing apparatus by processing location-based data received from and associated with the user and with the at least one driver, or (b) an external service, or (c) partly by the computing apparatus and partly by the external service.

9. The computing apparatus of claim 8, wherein the social media module for selectively associating the user with the at least one driver and with at least one ride hailing service, with data and ratings associated with the at least one user, with data and ratings associated with the at least one driver, with data associated with at least one calendar, and with data associated with the at least one map and with traffic conditions, uses common database keys associating two or more database tables together, or pointers to linked lists with entries created from the databases tables.

10. The computing apparatus of claim 7, wherein the creating the group of favorite drivers comprises the user performing at least one of:
browsing driver profiles stored by the social media module;
browsing comments associated with the driver profiles and stored by the social media module;
browsing ratings associated with the driver profiles and stored by the social media module;
selecting at least one driver using the comments and ratings associated with the driver profiles; and
associating the selected at least one driver with the group of favorite drivers.

11. A non-transitory computer program product that causes a system to personalize ride hailing services, the non-transitory computer program product having instructions to:
cause at least a user computing device associated with a user to (a) access ride hailing services, (b) capture location-based data associated with the user, (c) process and consume the ride hailing services, (d) store data associated with at least one user, with at least one driver, and with the ride hailing services, and (e) interact with the user;
cause at least a driver computing device associated with a driver to (a) access the ride hailing services, (b) capture location-based data associated with the driver, (c) process and consume the ride hailing services, (d) store data associated with at the least one driver, with at the least one user, and with the ride hailing services, and (e) interact with the driver; and
cause a computing apparatus to (a) serve the ride hailing services to the at least one user computing device and to the at least one driver computing device, (b) use a social media module for selectively associating the at least one user with the at least one driver and with the at least one ride hailing service, with data and ratings associated with the at least one user, with data and ratings associated with the at least one driver, with data associated with at least one calendar, and with data associated with at least one map and with traffic conditions, (c) store data associated with the at least one driver, with the at least one user, with the ride hailing services, with the social media module, with the at least one calendar, with the at least one map and with the traffic conditions, and (d) manage and serve the ride hailing services using the social media module, and the data associated with the at least one calendar, with the at least one map and with the traffic conditions.

12. The non-transitory computer program product of claim 11, wherein the ride hailing services comprise:
creating a user profile using the social media module;
setting user preferences using the social media module;
creating a group of users and associating the group of users with at least one user using the social media module;
creating a driver profile using the social media module;
creating a driver group and associating the driver group with at least one driver using the social media module;
creating a group of favorite drivers and associating the group of favorite drivers with one user profile and with at least one driver profile using the social media module;
creating a ride by having the user select a start location, a destination, a time-date, and a driver using data from the social media module, and the processing apparatus creating a ride using the data from the map server, the traffic server, and the calendar;
creating a ride by having the user select a start location, a destination, a time-date, and at least one favorite driver group using data from the social media module, and the processing apparatus creating at least one ride using the data from the social media module, the map server, the traffic server, and the calendar;
creating a ride by having the user select a start location, a destination, and a time-date, and the processing apparatus first selecting a driver using the data from the social media module and then creating a ride using the data from the map server, the traffic server, and the calendar;
confirming the created ride; and
paying the cost of the confirmed ride using a payment server.

13. The non-transitory computer program product of claim 12, wherein:
the map is implemented either as (a) a module of the computing apparatus, or (b) as an external service accessed by the computing apparatus, or (c) partly as the module of the computing apparatus and partly as the external service; and
the traffic conditions are created either by (a) the computing apparatus by processing location-based data received from and associated with the user and with the at least one driver, or (b) an external service, or (c) partly by the computing apparatus and partly by the external service.

14. The non-transitory computer program product of claim 13, wherein the social media module for selectively associating the user with the at least one driver and with at least one ride hailing service, with data and ratings associated with the at least one user, with data and ratings associated with the at least one driver, with data associated with at least one calendar, and with data associated with the at least one map and with traffic conditions, uses common database keys associating two or more database tables together, or pointers to linked lists with entries created from the databases tables.

15. The non-transitory computer program product of claim 12, wherein the creating the group of favorite drivers comprises the user performing at least one of:
browsing driver profiles stored by the social media module;
browsing comments associated with the driver profiles and stored by the social media module;
browsing ratings associated with the driver profiles and stored by the social media module;
selecting at least one driver using the comments and ratings associated with the driver profiles; and
associating the selected at least one driver with the group of favorite drivers.

16. A computer implemented method for personalizing ride hailing services, the method comprising:
using a communications interface for serving the ride hailing services to at least one user computing device associated with at least one user and to at least one driver computing device associating with at least one driver;
using a social media module for selectively associating at least one user with at least one driver and with at least one ride hailing service, with data and ratings associated with the at least one user, with data and ratings associated with the at least one driver, with data associated with at least one calendar, and with data associated with at least one map and with traffic conditions;
using a memory module for storing data associated with the at least one driver, with the at least one user, with the ride hailing services, with the social media module, with the at least one calendar, with the at least one map and with the traffic conditions; and
using a processor for managing and serving the ride hailing services using the social media module, and the data associated with the at least one calendar, with the at least one map and with the traffic conditions.

17. The computer implemented method of claim 16, the method comprising:
creating a user profile using the social media module;
setting user preferences using the social media module;
creating a group of users and associating the group of users with at least one user using the social media module;
creating a driver profile using the social media module;
creating a driver group and associating the driver group with at least one driver using the social media module;
creating a group of favorite drivers and associating the group of favorite drivers with one user profile and with at least one driver profile using the social media module;
creating a ride by having the user select a start location, a destination, a time-date, and a driver using data from the social media module, and the processing apparatus creating a ride using the data from the map server, the traffic server, and the calendar;
creating a ride by having the user select a start location, a destination, a time-date, and at least one favorite driver group using data from the social media module, and the processing apparatus creating at least one ride using the data from the social media module, the map server, the traffic server, and the calendar;
creating a ride by having the user select a start location, a destination, and a time-date, and the processing apparatus first selecting a driver using the data from the social media module and then creating a ride using the data from the map server, the traffic server, and the calendar;
confirming the created ride; and
paying the cost of the confirmed ride using a payment server.

18. The computer implemented method of claim 17, wherein:
the map is implemented either as (a) a module of the computing apparatus, or (b) as an external service accessed by the computing apparatus, or (c) partly as the module of the computing apparatus and partly as the external service; and
the traffic conditions are created either by (a) the computing apparatus by processing location-based data received from and associated with the user and with the at least one driver, or (b) an external service, or (c) partly by the computing apparatus and partly by the external service.

19. The computer implemented method of claim 18, wherein the social media module for selectively associating the user with the at least one driver and with at least one ride hailing service, with data and ratings associated with the at least one user, with data and ratings associated with the at least one driver, with data associated with at least one calendar, and with data associated with the at least one map and with traffic conditions, uses common database keys associating two or more database tables together, or pointers to linked lists with entries created from the databases tables.

20. The computer implemented method of claim 17, wherein the creating the group of favorite drivers comprises the user performing at least one of:
browsing driver profiles stored by the social media module;
browsing comments associated with the driver profiles and stored by the social media module;
browsing ratings associated with the driver profiles and stored by the social media module;
selecting at least one driver using the comments and ratings associated with the driver profiles; and
associating the selected at least one driver with the group of favorite drivers.
